(19) United States
(12) Patent Application Publication
(10) Pub. No.: US 2020/0346231 A1
(43) Pub. Date: Nov. 5, 2020

(54) SPRAYER

(71) Applicant: Shenzhen Kizoku Life Technology Co., Ltd., Shenzhen (CN)

(72) Inventor: YONGKANG LAI, Shenzhen (CN)

(21) Appl. No.: 16/931,470

(22) Filed: Jul. 17, 2020

Related U.S. Application Data
(63) Continuation of application No. PCT/CN2018/073203, filed on Jan. 18, 2018.

(51) Int. Cl. B05B 7/04; B05B 11/06; B05B 9/08

(52) U.S. Cl. CPC B05B 7/0416; B05B 9/0861; B05B 11/061

(57) ABSTRACT

The present disclosure provides a sprayer. The sprayer includes the spraying part. A spraying needle penetrates a first control channel and passes through a second water channel to reach a spraying end. A control block is connected with the spraying needle, the spraying needle is fitted in with an inner wall of a second control channel to block the water passing through the second control channel, meanwhile, the control block blocks an air inlet hole, and water in a water tank is separated from the atmospheric pressure. When the spraying needle is separated from the second control channel, the control block is distal to the air inlet hole, water in the water tank is communicated with atmospheric pressure, and the water reaches the spraying end through the second control channel.

### CROSS REFERENCE TO RELATED APPLICATIONS

The present application is a continuation-application of International (PCT) Patent Application No. PCT/CN2018/073203 filed on Jan. 18, 2018, the entire contents of which are hereby incorporated by reference.

### TECHNICAL FIELD

The present disclosure relates to a field of sprayers.

### BACKGROUND

Current sprayers need to be provided with at least two holes on a water tank, where one hole is for flowing out water from the water tank, and the other hole is for the water tank to communicate with atmospheric pressure. This structure of the water tank needs two reserved holes, the two reserved holes are sealed during production, which process is complex and production cost is high. When the sprayer is in use, the two reserved holes need to be unsealed. A special piercing structure is disposed on a water channel to unseal the hole for flowing out the water, but the hole for the water tank to communicate with the atmospheric pressure needs to be unsealed manually, which is troublesome for users.

### SUMMARY

In order to solve above technical problems, the present disclosure provides a sprayer which water tank only needs one hole.

Technical solutions of the present disclosure are as follows.

The sprayer includes a spraying part, and the spraying part includes a spraying head, a first water-air adjusting part, a second water-air adjusting part, a spraying needle, a control block, and a water tank. A water-air channel is disposed on the spraying head, and the spraying head includes a spraying end. The water-air channel penetrates through the spraying head, the water-air channel extends from the spraying end to one end of the spraying head, and the one end of the the spraying head is distal to the spraying end. A first water channel, a first air channel, and a first spraying needle channel are disposed on the first water-air adjusting part. The first water channel intersects with the first spraying needle channel in a first control channel, an air inlet hole is disposed on the first water-air adjusting part, the air inlet hole is communicated with the first water channel and the first spraying needle channel. The first water channel is communicated with the water tank, and water in the water tank, driven by gravity, enters the first water channel. A second water channel and second air channels are disposed on the second water-air adjusting part. The second water-air adjusting part is connected with the spraying head, the second water channel is communicated with the spraying end, a third air channel is formed between the second water-air adjusting part and the spraying head, and the second air channels are communicated with the third air channel. The second water-air adjusting part is connected with the first water-air adjusting part, the first air channel is communicated with the second air channels, and the first water channel is communicated with the second water channel. Water in the first water channel passes through the second water channel to reach the spraying end, and air in the first air channel passes through the second air channels and the third air channel in sequence to reach the spraying end. The spraying needle passes through the first control channel and the second water channel in sequence to reach the spraying end. The spraying needle is connected with the control block, a second control channel is disposed on a position of the second water channel close to the spraying end. When the spraying needle is inserted into the second control channel, the spraying needle is fitted in with an inner wall of the second control channel to block the water passing through the second control channel, meanwhile, the control block blocks the air inlet hole, and the water in the water tank is separated from the atmospheric pressure. When the spraying needle is separated from the second control channel, the control block is distal to the air inlet hole, the water in the water tank is communicated with the atmospheric pressure, and the water reaches the spraying end through the second control channel.

Furthermore, a plurality of the second air channels are disposed, and the plurality of the second air channels are evenly distributed along the spraying needle.

Furthermore, the control block is in an annular shape, and the control block covers the air inlet hole along a direction where the spraying needle is inserted into the second control channel.

Furthermore, the spraying part further includes a first control part. The first control part includes a first connecting block, the first connecting block is connected with the spraying needle, and the first connecting block is distal to the spraying end.

Furthermore, the first control part further includes a first control block. The first control block includes a first control plate and a second connecting block, the first control plate is connected with the second connecting block. A rotating shaft is disposed on the first control block. The first control block is rotatably connected with the first water-air adjusting part through the rotating shaft.

When the sprayer is in use, users press the first control plate to rotate the second connecting block around the rotating shaft, the second connecting block acts on the first connecting block to drive the spraying needle to separate from the second control channel, meanwhile, the control block is distal to the air inlet hole.

Furthermore, an air pressure pump is connected with the first air channel. A control switch is disposed on the air pressure pump, and the control switch controls a starting of the air pressure pump.

When the users press the first control plate, the first control plate acts on the control switch. When the water is realized to enter the spraying end, air pressure generated by the starting of the air pressure pump enters the spraying end.

Furthermore, the sprayer further includes a power supply, and the starting of the air pressure pump is powered by the power supply. And a charging socket is disposed on the power supply.

Furthermore, a spraying groove is disposed on the spraying end of the spraying head. The second water channel is communicated with the spraying groove, and the third air channel is communicated with the spraying groove. The water and the air form mist spray in the spraying groove.

Furthermore, a water outlet is disposed on the water tank, and the water outlet is communicated with the first water channel.

Furthermore, the first control part further includes a second control block. The second control block slides along a direction perpendicular to the spraying needle, and the second connecting block is perpendicular to the first control plate. The rotating shaft is disposed on a position where the first control plate is perpendicularly connected with the second connecting block, the users press the second connecting block along the direction of the spraying needle to act on the first control plate, and the spraying needle moves to separate from the second control channel.

The spraying needle simultaneously controls water flow and the atmospheric pressure communicated with the water tank to ensure that the water stably and reliably flows to the spraying end. When the sprayer is not in use, due to a fact that the water tank is communicated with the first water channel, but the water in the first water channel does not flow, the water in the water tank is prevented from flowing out, so that sealing property of the water in the sprayer is increased.

### BRIEF DESCRIPTION OF DRAWINGS

FIG. 1 is a schematic diagram of a sprayer of the present disclosure.

FIG. 2 is a structural schematic diagram of a spraying part of the present disclosure.

FIG. 3 is a schematic diagram of a first water-air adjusting part of the present disclosure.

FIG. 4 is a schematic diagram of a second water-air adjusting part and a spraying head where the second water-air adjusting part and the spraying head are connected of the present disclosure.

FIG. 5 is a structural schematic diagram of a sprayer of the present disclosure.

### DETAILED DESCRIPTION

In order to facilitate those skilled in the art to understand the technical solutions of the present disclosure, the embodiments of the present disclosure are described below with referring to the accompanying drawings.

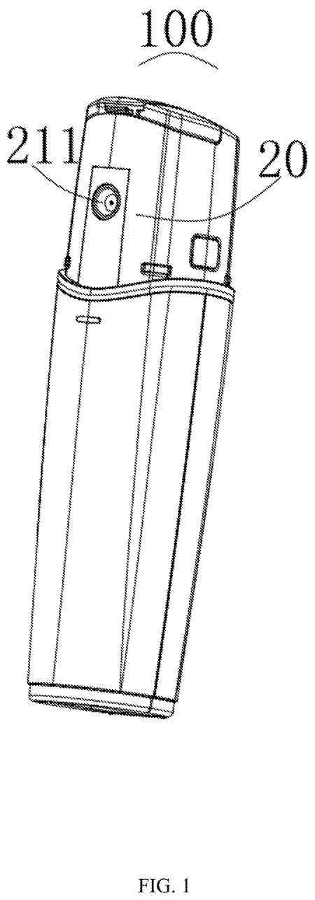

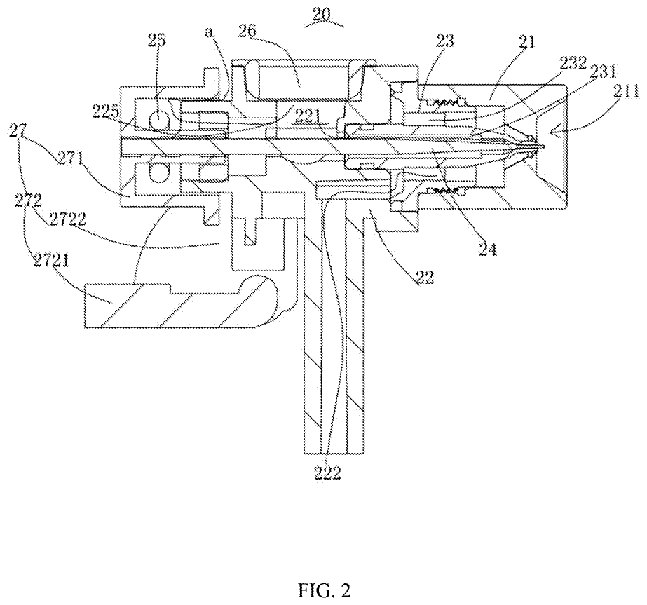

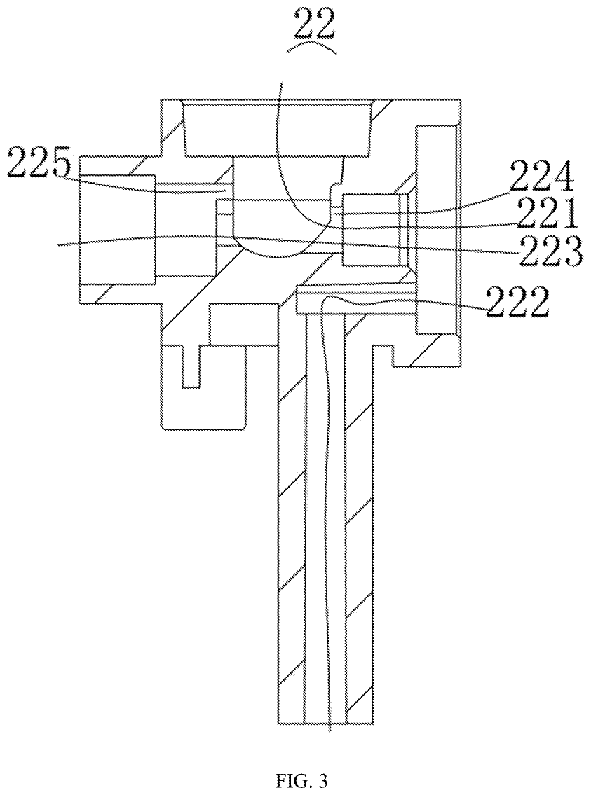

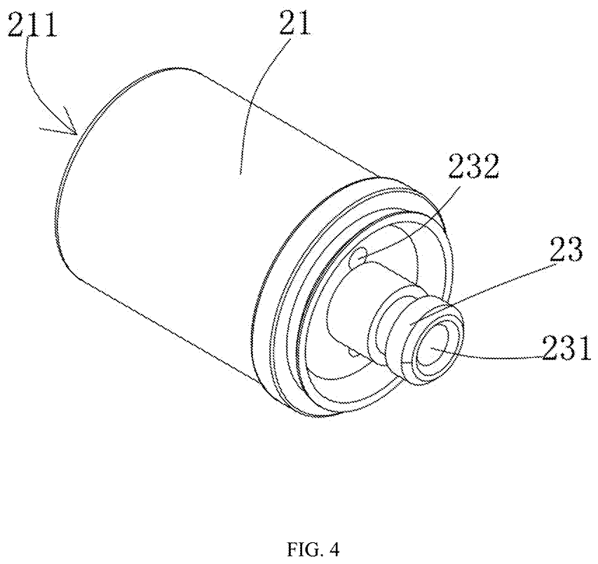

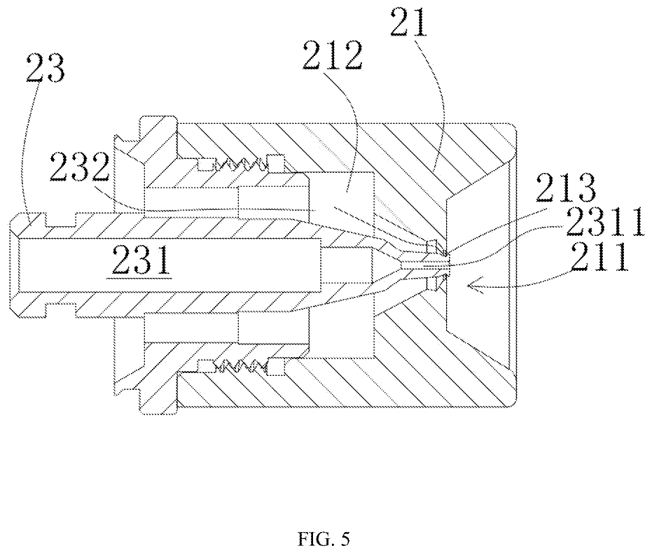

As shown in FIGS. 1-5, a sprayer 100 includes a spraying part 20, the spraying part 20 is configured to form mist spray, and the spraying part 20 is configured for the sprayer 100 but is not limited to the sprayer 100. The spraying part 20 includes a spraying head 21 configured to spray the mist spray formed by the spraying part 20 along a preset direction and scope, which enhances directionality of the mist spray and convenient for users to control the sprayer 100. A first water-air adjusting part 22 is configured to respectively guide water and air into the spraying part 20. This is not limited to the water, where users or producers may replace the water and the air into other fluids to form the mist spray according to requirements. A second water-air adjusting part 23 is configured to respectively guide the water and the air into the spraying end 211. A spraying needle 24 is configured to control flows of the fluids. In one embodiment, the spraying needles 24 is configured to control the flow of the water. A control block 25, in one embodiment, is configured to unseal a water tank 26 or block atmospheric pressure. The water tank 26, is configured to store the water or other fluids. A water-air channel 212 is disposed on the spraying head 21, and is configured to guide the water and the air along a preset direction to a preset position. The spraying head 21 includes the spraying end 211, the water and the air form the mist spray in the spraying end 211. The water-air channel 212 penetrates through the spraying head 21, which is convenient to make the spraying needle 24 as a straight needle to control, is simple in structure, and is low in cost. The water-air channel 212 extends from the spraying end 211 to one end of the spraying head 21, and the one end of the spraying head 21 is distal to the spraying end 211, which ensures that the water and the air are guided to the spraying end 211. A first water channel 221, a first air channel 222, and a first spraying needle channel 223 are disposed on the first water-air adjusting part 22. The first water channel 221 intersects with the first spraying needle channel 223 in a first control channel 224, an air inlet hole 225 is disposed on the first water-air adjusting part 22, the air inlet hole 225 is communicated with the first water channel 221 and the first spraying needle channel 223 to form a air guiding channel a. The first water channel 221 is communicated with the water tank 26, and water in the water tank 26, driven by gravity, enters the first water channel 221. When the water needs to flow in the first water channel 211, the water tank 26 is communicated with the air through the air inlet hole 225 to ensure that the water normally flows. A second water channel 231 and second air channels 232 are disposed on the second water-air adjusting part 23. The second water channel 231 is configured for the water flowing in the spraying end 211, and the second air channels 232 are configured for the air flowing to the spraying end 211. The second water-air adjusting part 23 is connected with the spraying head 21, the second water channel 231 is communicated with the spraying end 211 to ensure that the water must pass through the water channel 231 and then flow into the spraying end 211, so that a part matching with an outer diameter of the spraying needle 24 is convenient to be disposed on the second water channel, which realizes the spraying needle 24 to control the water to flow to the spraying end 211. The second water-air adjusting part 23 is connected with the spraying head 21, meanwhile, a third air channel 213 is formed between the second water-air adjusting part 23 and the spraying head 21. Thus, the third air channel 213 is ensured to be formed according to a preset shape and size, which ensures that the air stably flows to the spraying end 211. The second air channels 232 are communicated with the third air channel 213. The second water-air adjusting part 23 is connected with the first water-air adjusting part 22, the first air channel 222 is communicated with the second air channels 232, and the first water channel 221 is communicated with the second water channel 231. Water in the first water channel 221 passes through the second water channel 231 to reach the spraying end 211, which ensures that the water flows from the water tank 26 to the spraying end 211. Air in the first air channel 222 passes through the second air channels 232 and the third air channel 213 in sequence to reach the spraying end 211. The spraying needle 24 passes through the first control channel 224 and the second water channel 231 in sequence to reach the spraying end 211. The spraying needle 24 is connected with the control block 25, a second control channel 2311 is disposed on a position of the second water channel 231 close to the spraying end 211. When the spraying needle 24 is inserted into the second control channel 2311, the spraying needle 24 is fitted in with an inner wall of the second control channel 2311 to block the water passing through the second control channel 2311, meanwhile, the control block 25 blocks the air inlet hole 225, and the water in the water tank 26 is separated from the atmospheric pressure. When the spraying needle 24 is separated from the second control channel 2311, the control block 25 is distal to the air inlet hole 225, the water in the water tank 26 is communicated with the atmospheric pressure, and the water reaches the spraying end 211 through the second control channel 2311. The spraying needle 24 simultaneously controls water flow and the atmospheric pressure communicated with the water tank 26 to ensure that the water stably and reliably flows to the spraying end 211. When the sprayer 100 is not in use, due to a fact that the water tank 26 is communicated with the first water channel 221, but the water in the first water channel 221 does not flow, the water in the water tank 26 is prevented from flowing out, so that sealing property of the water in the sprayer 100 is increased. The air inlet 225 is not limited to communicate with the atmospheric pressure, and those skilled in the art may communicate the air inlet 225 with an inflation device after understanding the technical solution of the present embodiment, and control the inflation device to work simultaneously through controlling the spraying needle 24. Thus, controlling of the water flow and controlling of the water tank 26 communicating with the atmospheric pressure are realized. A plurality of the second air channels 232 are disposed, and the plurality of the second air channels 232 are evenly distributed along the spraying needle 24. The control block 25 is in an annular shape, and the control block 25 covers the air inlet hole 225 along a direction where the spraying needle 24 is inserted into the second control channel 2311. When the sprayer 100 is in use, the spraying needle 24 rotates, the control block 25 also covers the air inlet hole 225, which does not affect a use function of the sprayer 100.

As shown in FIGS. 1-5, the spraying part 20 further includes a first control part 27, the first control part 27 is configured to control the spraying needle 24 to rotate. The first control part 27 includes a first connecting block 271, the first connecting block 271 is connected with the spraying needle 24. The users move the first connecting block 27 to drive the spraying needle 24 moving, which is convenient and reliable. The first connecting block 271 is distal to the spraying end 211, distance between the spraying end 211 and the first connecting block 271 is increased, so that the sprayer 100 is used for all spraying directions, and using habits of the users are met.

As shown in FIGS. 1-5, the first control part 27 further includes a first control block 272. The first control block 272 includes a first control plate 2721 and a second connecting block 2722, the first control plate 2721 is connected with the second connecting block 2722. A rotating shaft is disposed on the first control block 272. The first control block 2721 is rotatably connected with the first water-air adjusting part 22 through the rotating shaft. Thus, the spraying needle 24 moves relative to the first water-air adjusting part 22 through the first control part 27 to ensure that the spraying needle 24 moves relative to the second water channel 231, which realizes a control function of the spraying needle 24 for the water flow.

When the sprayer 100 is in use, the users press the first control plate 2721 to rotate the second connecting block 2722 around the rotating shaft, the second connecting block 2722 acts on the first connecting block 271 to drive the spraying needle 24 to separate from the second control channel 2311, meanwhile, the control block 25 is distal to the air inlet hole 225. When the users move the spraying needle 24 toward theirs faces in a horizontal direction, the first control plate 2721 is pressed in a non-horizontal pressing operation, so that the sprayer 100 is convenient to operate and labor-saving. The first control part 27 further includes a second control block. The second control block slides along a direction perpendicular to the spraying needle 24, and the second connecting block is perpendicular to the first control plate 2721. The rotating shaft is disposed on a position where the first control plate 2721 is perpendicularly connected with the second connecting block 2722, the users press the second connecting block 2722 along the direction of the spraying needle 24 to act on the first control plate 252, and the spraying needle 24 moves to separate from the second control channel 2311. Thus, the users press the first control panel 2721 downward to horizontally move the spray needle 24, and the mist spray in the horizontal direction is formed. An air pressure pump is connected with the first air channel 222. A control switch is disposed on the air pressure pump, and the control switch controls a starting of the air pressure pump.

When the users press the first control plate 2721, the first control plate 272 acts on the control switch. When the water is realized to enter the spraying end 211, air pressure generated by the starting of the air pressure pump enters the spraying end 211. Thus, the sprayer 100 simultaneously controls the water and the air, which is convenient to use. The sprayer 100 further includes a power supply, and the starting of the air pressure pump is powered by the power supply. And a charging socket is disposed on the power supply, which is convenient to carry and use. The users use the sprayer 100 at any time according to their requirements.

As shown in FIGS. 1-5, a spraying groove is disposed on the spraying end 211 of the spraying head 21. The second water channel 231 is communicated with the spraying groove, and the third air channel 213 is communicated with the spraying groove. The water and the air form the mist spray in the spraying groove to ensure that the mist spray formed by the spraying part 21 diffuses along the spraying groove, which is convenient for the users to judge a direction of the mist spray and avoids embarrassment that the users spray the mist spray in a wrong direction. Meanwhile, the water and the power are saved, and a service life of the sprayer 100 is prolonged.

As shown in FIGS. 1-5, a water outlet is disposed on the water tank 26, and the water outlet is communicated with the first water channel 221. Thus, the water tank 26 is designed to have only one outlet, which is simple in structure and convenient in use.

The above is a preferred embodiment of the present disclosure and is not intended to limit the scope of the present disclosure. It should be understood that those skilled in the art, upon attaining an understanding of the technical solutions of the present disclosure, do not involve any inventive variations and modifications, and should also fall within the scopes of the present disclosure.

What is claimed is:

1. A sprayer, comprising a spraying part;
wherein the spraying part comprises a spraying head, a first water-air adjusting part, a second water-air adjusting part, a spraying needle, a control block, and a water tank;
a water-air channel is disposed on the spraying head, and the spraying head comprises a spraying end; the water-air channel penetrates through the spraying head, the water-air channel extends from the spraying end to one end of the spraying head, and the one end of the spraying head is distal to the spraying end;
a first water channel, a first air channel, and a first spraying needle channel are disposed on the first water-air adjusting part; the first water channel intersects with the first spraying needle channel in a first control channel; an air inlet hole is disposed on the first water-air adjusting part, the air inlet hole is communicated with the first water channel and the first spraying needle channel; the first water channel is communicated with the water tank, and water in the water tank, driven by gravity, enters the first water channel;
a second water channel and second air channels are disposed on the second water-air adjusting part; the second water-air adjusting part is connected with the spraying head, the second water channel is communicated with the spraying end, a third air channel is formed between the second water-air adjusting part and the spraying head, and the second air channels are communicated with the third air channel; the second water-air adjusting part is connected with the first water-air adjusting part, the first air channel is communicated with the second air channels, and the first water channel is communicated with the second water channel; water in the first water channel passes through the second water channel to reach the spraying end, and air in the first air channel passes through the second air channels and the third air channel in sequence to reach the spraying end; and
the spraying needle passes through the first control channel and the second water channel in sequence to reach the spraying end; the spraying needle is connected with the control block, a second control channel is disposed on a position of the second water channel close to the spraying end; when the spraying needle is inserted into the second control channel, the spraying needle is fitted in with an inner wall of the second control channel to block the water passing through the second control channel, meanwhile, the control block blocks the air inlet hole, and the water in the water tank is separated from the atmospheric pressure; when the spraying needle is separated from the second control channel, the control block is distal to the air inlet hole, the water in the water tank is communicated with the atmospheric pressure, and the water reaches the spraying end through the second control channel.

2. The sprayer according to claim 1, wherein a plurality of the second air channels are disposed, and the plurality of the second air channels are evenly distributed along the spraying needle.

3. The sprayer according to claim 1, wherein the control block is in an annular shape, and the control block covers the air inlet hole along a direction where the spraying needle is inserted into the second control channel.

4. The sprayer according to claim 2, wherein the control block is in an annular shape, and the control block covers the air inlet hole along a direction where the spraying needle is inserted into the second control channel.

5. The sprayer according to claim 1, wherein the spraying part further comprises a first control part; and
the first control part comprises a first connecting block, the first connecting block is connected with the spraying needle, and the first connecting block is distal to the spraying end.

6. The sprayer according to claim 5, wherein the first control part further comprises a first control block;
the first control block comprises a first control plate and a second connecting block, the first control plate is connected with the second connecting block; a rotating shaft is disposed on the first control block; the first control block is rotatably connected with the first water-air adjusting part through the rotating shaft; and
when the sprayer is in use, users press the first control plate to rotate the second connecting block around the rotating shaft, the second connecting block acts on the first connecting block to drive the spraying needle to separate from the second control channel, meanwhile, the control block is distal to the air inlet hole.

7. The sprayer according to claim 6, wherein an air pressure pump is connected with the first air channel; a control switch is disposed on the air pressure pump, and the control switch controls a starting of the air pressure pump; and
when the users press the first control plate, the first control plate acts on the control switch; when the water is realized to enter the spraying end, air pressure generated by the starting of the air pressure pump enters the spraying end.

8. The sprayer according to claim 7, wherein the sprayer further comprises a power supply, and the starting of the air pressure pump is powered by the power supply; and
a charging socket is disposed on the power supply.

9. The sprayer according to claim 1, a spraying groove is disposed on the spraying end of the spraying head; the second water channel is communicated with the spraying groove, and the third air channel is communicated with the spraying groove; and
the water and the air form mist spray in the spraying groove.

10. The sprayer according to claim 1, wherein a water outlet is disposed on the water tank, and the water outlet is communicated with the first water channel.

11. The sprayer according to claim 6, wherein the first control part further comprises a second control block; the second control block slides along a direction perpendicular to the spraying needle; and
the second connecting block is perpendicular to the first control plate; the rotating shaft is disposed on a position where the first control plate is perpendicularly connected with the second connecting block, the users press the second connecting block along the direction of the spraying needle to act on the first control plate, and the spraying needle moves to separate from the second control channel.
